(19) United States
(12) Patent Application Publication
(10) Pub. No.: US 2017/0233906 A1
(43) Pub. Date: Aug. 17, 2017

(54) Seamless Double Layered Porous Woven Structure

(71) Applicant: Yu Chen Hwang, Zhongli Dist (TW)

(72) Inventor: Yu Chen Hwang, Zhongli Dist (TW)

(21) Appl. No.: 15/430,363

(22) Filed: Feb. 10, 2017

(30) Foreign Application Priority Data
Feb. 15, 2016 (TW) 105202202

(51) Int. Cl. D03D 15/08; B32B 5/26; B32B 5/02; B32B 5/06; D03D 15/00; A41C 3/00

(52) U.S. Cl. CPC D03D 15/08; D03D 15/00; A41C 3/0057; B32B 5/024; B32B 5/06; B32B 5/26; D10B 2401/061; B32B 2307/724; B32B 2307/71; B32B 2307/7145; B32B 2307/304; B32B 2307/202; B32B 2307/422; B32B 2437/00

(57) ABSTRACT

A seamless double layered porous woven structure comprises a seamless circular inner layer structure and a porous outer layer structure. The outer layer structure is weaved upon the seamless circular inner layer structure to provide a seamless double layered tubular structure, which is further gaited together with yarns at the edges of the double layered tubular structure. The inner layer structure is made of circular weaving process while the outer layer structure is made of warp weaving process. There are several porous regions and jacquard regions at the outer layer structure.

### RELATED APPLICATIONS

This application claims priority of Taiwan Patent Application No. 105202202, filed Feb. 15, 2016, the entire disclosure of which is incorporated herein by reference.

### BRIEF SUMMARY

Circular weaving process is known to be capable of weaving yarns with different colors simultaneously into seamless tubular shape. Warp weaving process can achieve weaving density variation and porous design. In this invention, we utilize the characteristics of circular weaving to provide a multi-color seamless circular tube and followed with a secondary warp weaving process right on top of seamless circular woven tube, and thus provides a seamless double layered porous woven structure. The combination of two technologies has several advantages including colorful effect, porous breathable function and localized jacquard design. This invention also fully utilizes the high production speed of circular weaving technology. The resulting breathable fabrics are very suitable for multi-purpose applications, e.g. colorful fashion clothing, sportswear, shoe uppers, socks and bags. The breathable fabrics can also be used for underwear, sportswear, sports underwear, medical fabrics, luggage, travel hag, back pack, suitcase and shoe uppers for casual, indoor, heat insulation, running, hiking, cross training, dancing, aerobic, and boot.

### BACKGROUND

With the increase in living standard, more comfortable fabrics with additional functions are expected. The permeability of fabric or woven products has gained more attentions. Therefore, fabrics with both good air permeability and good retention of body temperature are desired to meet the extreme environment temperatures due to global warming. Fabric requires to breathe and to provide the cool feeling in summer, and insulation to keep warm in winter.

The compounded weaving technology is still at early development stage. Therefore, it is not easy to obtain good performance multi-functional fabrics. Consumers strongly desire to have thin and light weight clothing which can breathe to provide the comfort and also keep warm at low temperature. It will enable various designs for functional clothing and footwear. Most common issues in clothing are lack of air permeability and frictions at the seam lines. Although warp weaving process can generate holes to provide the desired permeability, it can only weave yarns into flat structures and cannot avoid the discomfort resulting from the seaming areas. On the other hand, circular weaving, a type of weft weaving, can form seamless tubular structure. It resolves the seaming issue but cannot provide large holes to improve permeability. In additions, circular weaving is good for large quantity production with very limited function for tailor made design. The resulted products are usually for low value market, and cannot meet the consumer desire for differentiation. Therefore, a compounded weaving process was developed based on the combination of circular weaving and warp weaving to provide a seamless double layered porous woven structure, which shows colorful design, high permeability with localized jacquard design. It resolves the issues from traditional circular weaving and warp weaving, and is expected to have very high market value.

### DETAILED DESCRIPTION

In order to resolve the issues described previously, the purpose of this invention is to provide a compounded seamless bi-layered fabric woven structure which is thin with good air permeability and thermal insulation properties. It will have multiple purposes and resolve the issues of thermal insulation material being too thick and not breathable. The woven product should also provide good flexibility, dimension stability and comfort.

In order to achieve the purpose, a compounded weaving process is proposed to utilize the seamless characteristics of circular weaving and utilizing the crochet needle flipping device to create braided yarn around the pores for pore edge reinforcement and reduce the running yarn issues of circular weaving. Furthermore, crochet needle transfer and crochet needle flipping devices in warp weaving enables the creation of large porous structure and stereoscopic jacquard effects. This invention provides a method to produce seamless hi layered multi-color porous woven structures.

In order to achieve the desired seamless double layered porous woven structure, a circular weaving machine with several crochet needle selectors and a crochet needle flipping device was used. A weaving plan bases on weaving machine structural map was created, including several weaving regions with different weaving density and pore arrangement. Weaving several regions simultaneously can be achieved through several crochet needle selectors to twist several yarns into yarn loops based on different density in the weaving plan. According to the pore arrangement in the weaving plan, several porous regions were achieved with a modified crochet needle transfer and crochet needle flipping devices. Through crochet needle transfer and/or crochet needle flipping technique, the newly created neighboring yarn loops, located at left, right, up or down side of the needle, were transferred to form braided yarns structures.

In this invention, we created a seamless double layered porous woven structure comprising a seamless circular inner layer structure and a porous outer layer structure. The outer layer structure is weaved upon the seamless circular inner layer structure to provide a seamless double layered tubular structure, which is further grafted together by yarns at the edges of the double layered tubular structure.

The inner layer structure is made of circular weaving process while the outer layer structure is made of warp weaving process. There are several porous regions and jacquard regions at the outer layer structure.

Furthermore, both the inner layer and outer layer have multiple pores. The pores from different layers can be located at exactly the same location to create through holes. The pores from different layers can also be located at different locations to create half-through holes.

Furthermore, there are several regions in both inner layer and outer layer. The jacquard patterns can be the same or different among regions.

Furthermore, the inner layer is created as seamless tubular structure with holes, jacquard and multiple colors by circular weaving process.

Furthermore, the modified crochet needle flipping device can flip the yarn loops from up(down) or left(right) crochet needle bed to down(up) or right(left) crochet needle bee vertically or horizontally to create braided structure around the pores and reinforce the pore edges and strength, and control the pore size.

Furthermore, the inner layer and outer layer can be separated two layers in some areas and inseparable in some areas.

The modified crochet needle flipping device can flip the yarn loops from up(down) left(right) crochet needle bed to down(up) or right(left) crochet needle bed vertically or horizontally to create braided yarn around the pores to reinforce the pore edges and strength, and control the pore size. In order to achieve beautiful visual effect in porous circular weaving, the yarns are in more than two colors for bright and vivid patterns and jacquard effects based on weaving plan and weaving density.

Furthermore, the inner layer structure and/or outer layer structure have patterns of UV ink printing or digital printing to create regional visual jacquard effect, e.g. protruded logo or stereoscopic patterns.

Furthermore, single sided or double sided loop terry woven fabrics can be obtained through circular loop terry weaving device. The resulting woven structures provide the properties of soft touch feeling, thick, sturdy, flexible, good moisture pickup and comfort to wear. They can be used for clothes, shoe uppers, socks or baggage materials.

Warp weaving is performed on the close loop terry woven fabric made from circular weaving to provide a double layered breathable woven structure, which poses good stiffness and good permeability and less running yarns. The edge does not have roll up issue and the whole structure is highly flexible. The fabric structure is especially suitable for the applications in clothing, shoe uppers, socks or bags.

Preferably, the yarns for weaving the double layer porous structure are chosen from natural fibers, naturally synthesized fibers, recycled fibers or synthetically polymerized fibers or the combinations of above materials,

Preferably, the yarns can be single fiber yarn, elastic fiber yarn, hot melt yarn or the combinations of above materials. The yarns can also have functions like UV blocking, anti-bacteria, thermal barrier, air permeability, conductive metal fiber, phosphorescent or photo absorption properties.

A seamless sports bra comprises a seamless stereobate, a circular inner layer structure and a porous outer layer structure; wherein the outer layer structure weaved upon the seamless circular inner layer structure to provide a seamless double layered chest structure with integrated shoulder straps; wherein the ends of shoulder straps are grafted together by yarns into one piece.

The seamless double layered porous woven structure is developed based on the extensive experience we have on circular weaving. Traditional circular weaving machine has horizontal left and right weaving pattern. We modified it with additional vertical, up and down, weaving capability. Through the computer controlled needle selection, needle transfer, needle flipping techniques, we achieve a one-piece stereoscopic surfaced woven structure, which is composed of two porous layers in multiple colors, breathable, elastic with jacquard pattern. Our woven structure has the following advantages.

1. Technology breakthrough: There is no need to turn yarns into fabric, then cut and sew fabric into clothing. It not only saves labor cost, but also shortens the fabrication process of making clothes. This technology also has better control with yarns. There is almost zero waste for the seamless process; therefore, there are additional savings from wasted yarns due to the cutting and sewing process. Traditionally, porous structures can only be achieved by warp weaving process. In this invention, a crochet needle transfer and crochet needle flipping device was added to a circular weaving machine. Crochet needle Cit up(down) or left(right) crochet needle bed cart be turned into down(up) or right(left) crochet, needle bed to create braided structure around the pores and reinforce the pore edges. Thus, the modified circular weaving technique can provide a colorful jacquard tubular woven structure with protruded pores. The resulting woven structure can be further decorated by externally laminated patterns or digital printing with UV ink to provide regional jacquard with stereoscopic visual effect for 3D logo or 3D pattern applications.

2. Shorter manufacturing process: This technology allows faster product development cycle. Multiple product development protects and manufacturing can be executed at the same time. This technology fully utilizes the characteristics of circular weaving for mass production with multiple color yarns and different material types. Then, warp weaving is applied as secondary process to create a seamless double layered porous woven structure. This technology has design flexibility and multiple functionalities desired by customers, and creates value and profit for customers.

The weaving structure in this invention provides the best weaving efficiency. The resulting seamless double layered porous woven structure has the design flexibility of multiple color effect for elegant products, and reduced cost for dyeing.

The seamless double layered porous woven structure is developed based on extensive experience of computer controlled circular weaving in combination of needle selection, needle transfer and needle flipping techniques to achieve an innovative way to produce pores and vertical jacquard, which gives stereoscopic effect. The resulted one piece woven structure is colorful, double porous layered, air permeable and flexible. This modified circular technology achieves the combination of high air permeability with good visual and aesthetic appearance. Furthermore, the modified circular weaving process is integrated with warp weaving process to provide composite functional woven design. It enables the best weaving efficiency ever and provides flexible design with vivid colors and reduces the cost needed for dyeing. It is suitable for highly elegant woven products in seamless double layered porous structured.

In this invention, an air permeable woven structure with multiple porous regions was achieved by circular weaving machine equipped with needle transfer and needle flipping design. The circular machine was computer controlled for mass production of one piece seamless double layered air permeable woven structure based on a single or double sided jacquard weaving plan. The weaving plan includes regional weaving density and pore density distribution. The modified circular machine has several needle selectors, and needle transfer and flipping devices. The resulting air permeable circular woven structure contains several woven regions and several porous regions. The woven regions are accomplished by multiple needle selectors with multiple yarns twisted into multiple loops based on pre-determined weaving density. The porous regions are accomplished by modified needle transfer and flipping device to braid the newly created loops: nearby, at left right up and down into pores based on pre-determined pore density.

In order to address the unmet needs in traditional weaving technology, the goal of this invention is to provide high air permeable woven structure. Compare to warp weaving, circular weaving has the advantage of small quantity production, and using yarns in multiple colors and multiple material types simultaneously. Therefore, circular weaving is more suitable for prototyping.

### BRIEF DESCRIPTION OF THE DRAWINGS

FIG. 1 shows the front schematic diagram of a seamless double layered porous woven structure.

FIG. 2 shows the back schematic diagram of a seamless double layered porous woven structure.

FIG. 3 shows the schematic diagram of the A-A cross section of a seamless double layered porous woven structure in FIG. 2.

FIG. 4 shows the schematic diagram of the B-B cross section of a seamless double layered porous woven structure in FIG. 2.

### EMBODIMENTS

Example embodiment of the present invention is described below. However, the present invention should be in no way restricted by the examples.

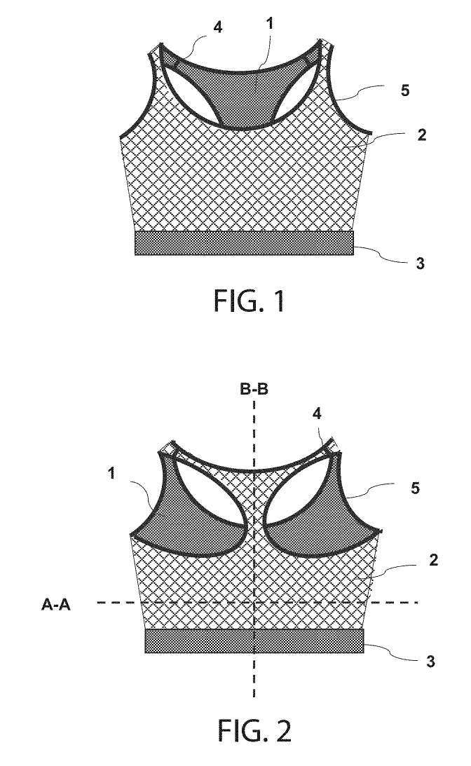

A seamless sports bra was used as an example to illustrate our technology. FIG. 1 shows the front schematic diagram of a seamless double layered porous woven structure. Cotton yarns containing 10% elastic fibers were used for circular weaving to produce an inner layer structure 1 and a seamless elastic woven stereobate 3. Warp weaving was applied on top of the inner layer structure 1 to create an outer layer structure 2. Based on a weaving plan with weaving density and pore density distribution, the warp weaving machine has a needle transfer device to flip the yarn loops from up(down) or left(right) crochet needle bed to down(up) or right(left) crochet needle bed to create pores with braided yarn around them for pore edges reinforcement. Both the inner layer structure 1 and the outer layer structure 2 are seamless tubular chest shape with integrated shoulder straps, which were, grafted together by stitched yarns. A cloth strip was used to form a bordure and covered both the inner layer structure 1 and the outer layer structure 2; and thus a double layered sports bra was created with chest area being seamless.

A circular weaving plan with weaving density and pore density distribution was created. The circular machine was equipped with several needle selectors and modified with needle flipping devices. Based on the plan, several woven regions and several porous regions were formed. The woven regions were accomplished by multiple needle selectors with multiple yarns twisted into multiple loops based on pre-determined weaving density. The porous regions were accomplished by a modified crochet needle transfer and flipping device to braid the newly created yarn loops nearby, at left right up and down, into pores based on pre-determined pore density. The modified crochet needle transfer and flipping device was created to snag the yarns loops nearby, at left right up and down, for braiding and created holes and patterns based on pre-determined pore density design and provided a colorful jacquard woven product. The resulting woven products can be further decorated by externally laminated patterns or digital printing with UV ink to provide regional jacquard with stereoscopic visual effect for 3D logo or 3D pattern applications.

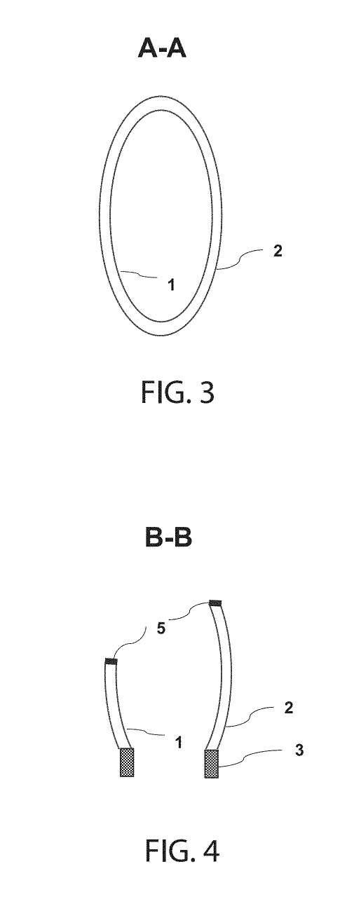

FIG. 2 shows the back schematic diagram of a seamless double layered porous woven structure. There is no fastener needed at the back of the sports bra example. The front and the back structures are in one piece. The ends of front and back shoulder straps were attached as a grated line 4 at the back shoulder to be less visible. As shown in FIG. 3 the A-A cross section shows that both inner layer structure 1 and the outer layer structure 2 of sports bra are in seamless tubular shape at the chest area.

In FIG. 4, the B-B cross section shows that the bordure is located at edge of the bra. A strip of fabric is usually used create bordure to eliminate the discomfort from the edges of woven structure.

Moreover, as those of skill in this art will appreciate, many modifications, substitutions and variations can be made in and to a method of making light guiding decorative composite sheet or components of these example embodiments without departing from its spirit and scope. In light of this, the scope of the present invention should not be limited to that of the particular embodiments illustrated and described herein, as they are only exemplary in nature, but instead, should fully commensurate with that of the claims appended hereafter and their equivalents.

### DESCRIPTION OF KEY ELEMENTS

1: inner layer structure
2: outer layer structure
3: elastic woven stereobate
4: grafted line
5: bordure

1. A seamless double layered porous woven structure comprises a seamless circular inner layer structure and a porous outer layer structure;
wherein the outer layer structure is weaved upon the seamless circular inner layer structure to provide a seamless double layered tubular structure;
wherein the edges of the double layered tubular structure are grafted together by yarns into one piece.

2. The seamless double layered porous woven structure of claim 1,
wherein the inner layer structure is made of circular weaving process while the outer layer structure is made of warp weaving process;
wherein there are several porous regions and jacquard regions at the outer layer structure.

3. The seamless double layered porous woven structure of claim 2,
wherein the porous regions are made with warp weaving machine based on a weaving plan including weaving density and pore arrangement;
wherein warp weaving machine has a crochet needle flipping device which flips yarn loops at up(down) or left(right) crochet needle bed to down(up) or right(left) crochet needle bed to create braided structure around the pores and reinforce the pore edges.

4. The seamless double layered porous woven structure of claim 2,
wherein the porous regions are created by warp weaving technology by loop transfer and/or crochet needle flipping methods to snag yarns to form braided structure.

5. The seamless double layered porous woven structure of claim 1,
wherein there are pores on both the inner layer structure and outer layer structure;
wherein the pores may be at same exact locations or different locations of the double layered tubular structure to create penetrated through holes or half-through holes.

6. The seamless double layered porous woven structure of claim 1,
wherein there are several jacquard regions with same or different jacquard patterns on both the inner layer structure and outer layer structure.

7. The seamless double layered porous woven structure of claim 1,
wherein both the inner layer structure and outer layer structure are made of yarns selected from natural fibers, naturally synthesized fibers, recycled fibers, synthetic fibers or the combinations of above materials;
wherein the fibers can be single fiber yarn, elastic fiber yarn, hot melt yarn;
wherein the yarns have functions like UV blocking, anti-bacteria, thermal barrier, air penetration, conductive metal fiber, phosphorescent or photo absorption properties.

8. The seamless double layered porous woven structure of claim 1,
wherein the inner layer structure is made of circular weaving method with multiple color yarns to produce tubular structure with protruded pores and jacquard regions.

9. The seamless double layered porous woven structure of claim 1,
wherein the inner layer structure and outer layer structure are both double layered structures in either separated or integrated form.

10. A seamless sports bra comprises a seamless stereobate, a circular inner layer structure and a porous outer layer structure;
wherein the outer layer structure is weaved upon the seamless circular inner layer structure to provide a seamless double layered chest shape structure with integrated shoulder straps;
wherein the ends shoulder straps are grafted together by yarns into one piece.

11. The seamless double layered porous woven structure of claim 1,
wherein the inner layer structure and/or outer layer structure have patterns of UV ink printing or digital printing to create regional visual jacquard effect.
